(19) United States
(12) Patent Application Publication
(10) Pub. No.: US 2013/0332932 A1
(43) Pub. Date: Dec. 12, 2013

(54) COMMAND CONTROL METHOD

(71) Applicant: FUJITSU LIMITED, Kawasaki (JP)

(72) Inventors: Hirotsugu TERUYA, Kawasaki (JP); Hideto Sakamoto, Kofu (JP)

(73) Assignee: FUJITSU LIMITED, Kawasaki (JP)

(21) Appl. No.: 13/965,353

(22) Filed: Aug. 13, 2013

Related U.S. Application Data
(63) Continuation of application No. PCT/JP2011/055764, filed on Mar. 11, 2011.

(51) Int. Cl. G06F 9/54

(52) U.S. Cl. CPC G06F 9/54
USPC 718/102

(57) ABSTRACT

A computer determines whether a first system call waiting for a response exists upon entry of a command to the computer, which first system call has been issued based on a different command entered into the computer prior to the command. In the case where the first system call exists, the computer carries out a process corresponding to the command with the use of a response result for the first system call. On the other hand, if the first system call does not exist, the computer issues a second system call.

### CROSS-REFERENCE TO RELATED APPLICATION

This application is a continuation application of International Application PCT/JP2011/055764 filed on Mar. 11, 2011 which designated the U.S., the entire contents of which are incorporated herein by reference.

### FIELD

The embodiments discussed herein are related to a computer command control method.

### BACKGROUND

Among processes executed on an operating system (OS) of a computer, some are executed in a kernel space having a higher level of privilege while others are executed in a user space having a lower level of privilege. In the case where a process in the user space calls an OS kernel function across the privilege boundary, a system call (also sometimes called “supervisor call”) is issued. With the issuance of a system call, the computer conducts security inspection including, for example, confirmation of an access right of the calling process. If there is no security problem, the computer passes control to a program to be implemented in the kernel space.

Functions provided by the OS kernel include management of system statistical information which indicates, for example, the hardware usage status and the process execution status. When a command for acquiring the system statistical information is entered into the computer, a process corresponding to the entered command is launched in the user space and, then, a system call is issued to refer to the system statistical information managed by the kernel. In response to the system call, the kernel provides the system statistical information to the process in the user space. For example, when a failure occurs in the operation of the computer, a user may input a command to acquire the system statistical information in order to analyze the cause of the failure.

A method used in a parallel computer system having multiple nodes connected to a network has been proposed in which monitor data sampled by individual nodes is brought together in one managing node and the gathered monitor data is displayed on a console device in real time. Another proposed method is directed to a technique to gather, in a single node, performance data individually sampled by multiple nodes included in a parallel computer and distribute the gathered performance data to multiple monitor computers. Yet another proposed method achieves fault tolerance by acquiring control to record checkpoint information before an application program issues a system call.
Japanese Laid-open Patent Publication No. 08-44680
Japanese Laid-open Patent Publication No. 09-330302
Japanese Laid-open Patent Publication No. 10-187616

A system call creates a relatively heavy processing load because it involves privilege level switching. Therefore, an increase in the load on the computer becomes an issue when multiple commands using functions with higher privilege levels (for example, commands for acquiring the system statistical information) are entered into the computer and a system call is issued for each of the commands.

As for a computer used by multiple users, such as a server computer, it is sometimes the case that commands are entered in parallel thereinto by two or more users. In addition, a command for acquiring the system statistical information may be entered continuously even during ordinary times in order to monitor the presence or absence of a failure. At the occurrence of a failure, a larger number of commands than the ordinary times are likely to be entered for the purpose of analyzing the cause of the failure. Thus, a large number of commands may be entered into the computer and the load of processing the commands may result in worsening the response speed and other performances of the computer.

### SUMMARY

According to one aspect, there is provided a command control method executed by a computer for issuing an operating system call and carrying out a process corresponding to a command. The command control method includes determining, by a processor of the computer, whether a first system call waiting for a response exists upon entry of the command to the computer, which first system call has been issued based on a different command entered into the computer prior to the command; carrying out, by the processor, the process corresponding to the command with the use of a response result for the first system call when the first system call exists; and issuing, by the processor, a second system call and carrying out the process corresponding to the command with the use of a response result for the second system call when the first system call does not exist.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a command control method;

FIG. 2 is a block diagram illustrating an example of hardware of an information processing device;

FIG. 3 is a block diagram illustrating an example of software of the information processing device;

FIG. 4 illustrates an example of command process execution on the information processing device;

FIG. 5 is a state transition diagram illustrating reference states of system statistical information;

FIG. 6 is a flowchart illustrating a process of acquiring the system statistical information;

FIG. 7 is a flowchart illustrating the process of acquiring the system statistical information, continuing from FIG. 6;

FIG. 8 illustrates an example of a sequence to acquire the system statistical information;

FIG. 9 is a first diagram illustrating an example of change in data in a memory area;

FIG. 10 is a second diagram illustrating the example of change in data in the memory area;

FIG. 11 is a third diagram illustrating the example of change in data in the memory area;

FIG. 12 is a fourth diagram illustrating the example of change in data in the memory area; and

FIG. 13 is a fifth diagram illustrating the example of change in data in the memory area.

### DESCRIPTION OF EMBODIMENTS

Several embodiments will be described below with reference to the accompanying drawings.

### (a) First Embodiment

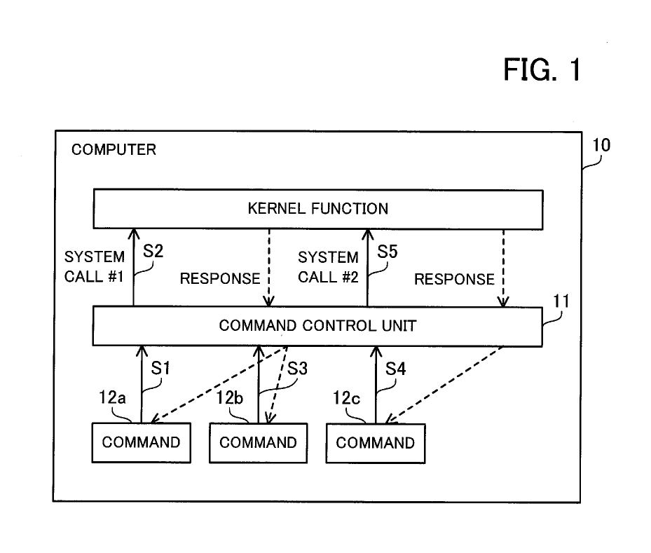

FIG. 1 illustrates an example of a command control method. A computer 10 receives multiple commands, and issues one or more OS system calls and carries out a process corresponding to each of the commands.

A command for acquiring system statistical information indicating, for example, the hardware usage status and the process execution status is an example of such commands. The system statistical information is managed, for example, in the kernel space. Each command may be entered by a user operation, or may be entered by a process running on the computer 10 or a different computer. Multiple commands may be of the same type, or may be of different types setting common information managed in the kernel space as their process targets.

The computer 10 includes a command control unit 11 for controlling issuance of a system call in response to a command entry. The command control unit 11 may be implemented as a program module (for example, a library program). Upon entry of a command to the computer 10, the command control unit 11 determines if there is a system call waiting for a response, which system call has been issued based on a different command entered into the computer 10 prior to the current command.

In the case where there is a system call waiting for a response, the command control unit 11 waits for a response to the existing system call without issuing a new system call. Once receiving a response result for the existing system call, the command control unit 11 causes a process corresponding to the entered command to be carried out with the use of the response result (for example, passes the response result to the process corresponding to the command). On the other hand, if there is no system call waiting for a response, the command control unit 11 issues a new system call. On receiving a response result for the newly issued system call, the command control unit 11 causes the process corresponding to the entered command to be carried out with the use of the response result.

For example, if there is no system call waiting for a response when a command 12a is entered (step S1), the command control unit 11 issues a system call #1 (step S2). If the system call #1 is waiting for a response when a command 12b is entered after the command 12a (step S3), the command control unit 11 does not issue a new system call. Subsequently, the command control unit 11 causes processes corresponding to the commands 12a and 12b to be carried out with the use of a response result for the system call #1. If there is no system call waiting for a response (i.e., if the response result for the system call #1 has already been received) when a command 12c is entered after the command 12b (step S4), the command control unit 11 issues a system call #2 (step S5). Subsequently, the command control unit 11 causes a process corresponding to the command 12c to be carried out with the use of a response result for the system call #2.

Note that, upon receiving a response result for a system call, the command control unit 11 may store the response result in a buffer of a memory and distribute the response result stored in the buffer to one or more processes individually corresponding to a command. In addition, the command control unit 11 may be configured to count, using a counter created in the memory, the number of commands entered for the duration of a system call waiting for a response and distribute the response result stored in the buffer by referring to the counter. Such a buffer may be created in the memory upon issuance of a system call, and may be deleted from the memory after completion of the response result distribution. The command control unit 11 may confirm the presence or absence of a buffer in the memory to thereby determine whether there is a system call waiting for a response.

According to the computer 10 of the first embodiment, it is determined whether a first system call waiting for a response exists upon entry of a command to the computer 10, which first system call has been issued based on a different command entered prior to the current command. If the first system call exists, a process corresponding to the command is carried out with the use of a response result for the first system call. On the other hand, if the first system call does not exist, a second system call is issued and a process corresponding to the entered command is carried out with the use of a response result for the second system call.

This reduces the number of issuances of system calls when multiple commands are entered as compared to the case where a system call is issued for each command, which in turn reduces the load imposed on the computer 10 in processing the commands. In addition, it is possible to prevent a command process from being carried out based on an old response result because a new system call is issued if there is no system call waiting for a response, thus promoting consistency between information managed in the kernel space and the command process. Furthermore, compared to the method where a cache of information managed in the kernel space is held in the user space at all times, the load for maintaining cache coherence is reduced.

The command control method according to the first embodiment is applicable to command processes for acquiring system statistical information as described above. The system statistical information may be updated by the kernel with a high frequency. A command for acquiring the system statistical information may be continuously entered into the computer 10 in order to monitor the presence or absence of a failure. At the occurrence of a failure, a large number of commands may be entered for the purpose of analyzing the cause of the failure. Furthermore, in the case where the computer 10 is a server computer or another electronic processor used by multiple users, commands may be entered in parallel thereinto by more than one user or by other computers. Therefore, the above-described command control method capable of reducing the load of command processes is effective especially in terms of improving the response speed of the command processes and thereby facilitating rapid failure analysis.

A second embodiment described below takes, as an example, an information processing device for processing commands for acquiring system statistical information. Note however that the command control method described in the first embodiment is applicable to commands other than the commands for acquiring system statistical information.

### (b) Second Embodiment

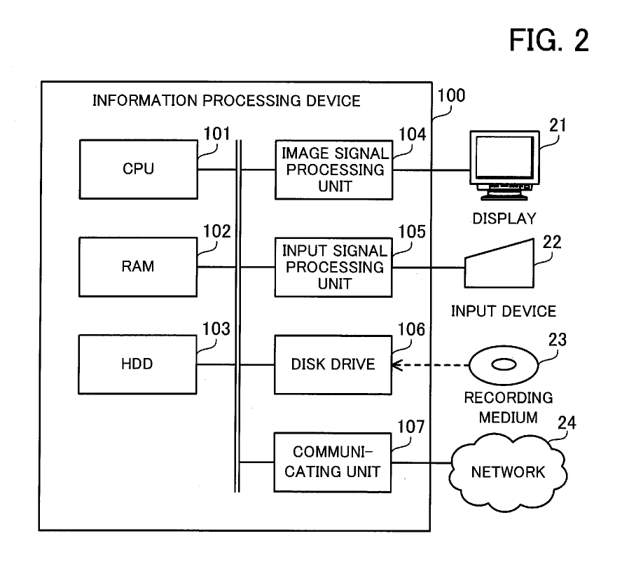

FIG. 2 is a block diagram illustrating an example of hardware of an information processing device. An information processing device 100 of the second embodiment includes a central processing unit (CPU) 101, a random access memory (RAM) 102, a hard disk drive (HDD) 103, an image signal processing unit 104, an input signal processing unit 105, a disk drive 106, and a communicating unit 107. These units are connected to a bus inside the information processing device 100.

The CPU 101 is an operational unit for controlling information processing of the information processing device 100. The CPU 101 reads at least part of programs and data stored in the HDD 103 and loads them to the RAM 102 to implement the programs. Note that the information processing device 100 may be provided with multiple operational units and carry out the information processing in a distributed manner.

The RAM 102 is a volatile memory for temporarily storing therein programs and data to be used by the CPU 101. Note that the information processing device 100 may be provided with a different type of memory other than a RAM, or may be provided with multiple memories.

The HDD 103 is a nonvolatile memory device for storing therein programs, including an OS program and application programs, and data to be used for the information processing. According to instructions from the CPU 101, the HDD 103 reads and writes from and to a built-in magnetic disk. Note that the information processing device 100 may be provided with a different type of nonvolatile memory device other than a HDD (for example, a solid state drive (SSD)), or may be provided with multiple memory devices.

The image signal processing unit 104 outputs an image on a display 21 connected to the information processing device 100 according to an instruction from the CPU 101. A cathode ray tube (CRT) display or a liquid crystal display, for example, may be used as the display 21.

The input signal processing unit 105 acquires an input signal from an input device 22 connected to the information processing device 100 and informs the CPU 101 of the input signal. A pointing device, such as a mouse and a touch panel, or a keyboard, for example, may be used as the input device 22.

The disk drive 106 is a drive unit for reading programs and data recorded in a recording medium 23. The following disks may be used as the recording medium 23: a magnetic disk, such as a flexible disk (FD) and a HDD; an optical disk, such as a compact disc (CD) and a digital versatile disc (DVD); and a magneto-optical disk (MO). The disk drive 106 stores programs and data read from the recording medium 23 in the RAM 102 or the HDD 103, for example, according to an instruction from the CPU 101.

The communicating unit 107 is a communication interface for connecting to a network 24 to perform communication. The communicating unit 107 may be connected to the network 24 with a wired or wireless connection. That is, the communicating unit 107 may be a wired or wireless communication interface.

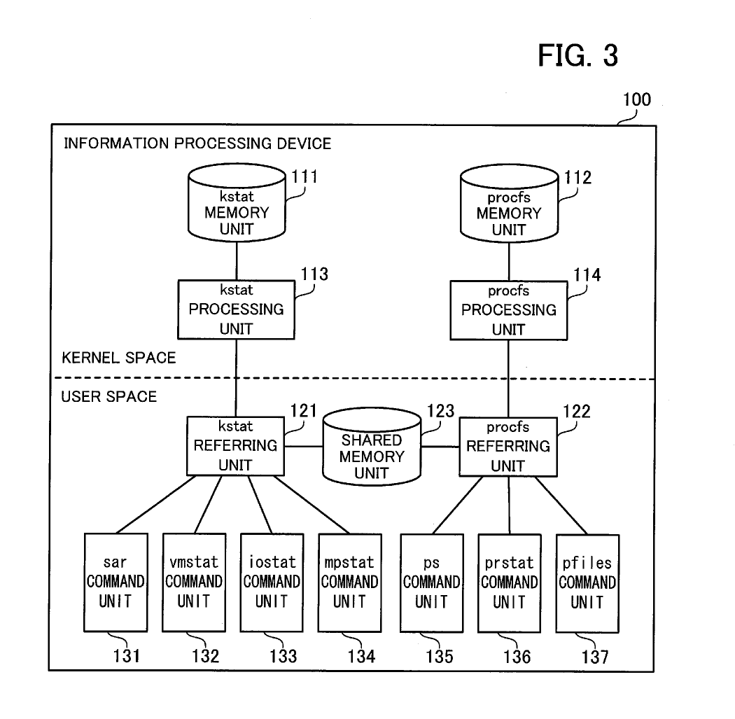

FIG. 3 is a block diagram illustrating an example of software of the information processing device. The information processing device 100 includes a kstat memory unit 111, a procfs memory unit 112, a kstat processing unit 113, a procfs processing unit 114, a kstat referring unit 121, a procfs referring unit 122, a shared memory unit 123, a sar command unit 131, a vmstat command unit 132, an iostat command unit 133, an mpstat command unit 134, a ps command unit 135, a prstat command unit 136, and a pfiles command unit 137.

The kstat memory unit 111, the procfs memory unit 112, and the shared memory unit 123 may be implemented as memory areas reserved in the RAM 102. The remaining units may be implemented as modules of a program to be executed by the CPU 101. The kstat memory unit 111, the procfs memory unit 112, the kstat processing unit 113, and the procfs processing unit 114 are located in the kernel space of the RAM 102. The remaining units are located in the user space of the RAM 102. In order for a module in the user space to call a module in the kernel space, a system call is issued.

The kstat memory unit 111 stores therein kernel statistics (kstat) which is a type of system statistical information. The kstat includes information indicating hardware usage status, such as load on the CPU 101, memory area usage of the RAM 102, frequency of input and output (I/O) accesses to the HDD 103, and bandwidth utilization of the communicating unit 107.

The procfs memory unit 112 stores therein process filesystem (procfs) which is another type of system statistical information. The procfs includes information indicating process execution status of the information processing device 100. Note that the kstat and the procfs are taken as examples of system statistical information according to the second embodiment, however, the kernel may hold other types of system statistical information.

With kernel privilege, the kstat processing unit 113 updates and reads the kstat stored in the kstat memory unit 111. The kstat processing unit 113 monitors the hardware usage status, and updates the kstat regularly (for example, every several milliseconds). When updating the kstat, the kstat processing unit 113 sets an exclusive lock in order to temporarily exclude access to the kstat. In addition, on receiving a system call from the kstat referring unit 121, the kstat processing unit 113 reads the kstat from the kstat memory unit 111 and writes the kstat to a memory area of the user space, designated by the kstat referring unit 121.

With kernel privilege, the procfs processing unit 114 updates and reads the procfs stored in the procfs memory unit 112. The procfs processing unit 114 monitors the process execution status of the information processing device 100, and updates the procfs each time the execution status changes (i.e., irregularly). When updating the procfs, the procfs processing unit 114 sets an exclusive lock in order to temporarily exclude access to the procfs. In addition, on receiving a system call from the procfs referring unit 122, the procfs processing unit 114 reads, from the procfs memory unit 112, all the procfs or a part of the procfs corresponding to predetermined number of blocks, and writes the read procfs to a memory area of the user space, designated by the procfs referring unit 122.

The kstat referring unit 121 controls issuance of a system call for referring to the kstat. The kstat referring unit 121 may be implemented, for example, as a library program to be called from the sar command unit 131, the vmstat command unit 132, the iostat command unit 133, and the mpstat command unit 134. The kstat referring unit 121 reserves, in the user space, a memory area for storing the kstat, and issues a system call with designation of the memory area. After acquiring the kstat, the kstat referring unit 121 distributes the kstat to one or more processes individually corresponding to a command. Note that operations of the kstat referring unit 121 are described in detail later.

The procfs referring unit 122 controls issuance of a system call for referring to the procfs. The procfs referring unit 122 may be implemented, for example, as a library program to be called from the ps command unit 135, the prstat command unit 136, and the pfiles command unit 137. The procfs referring unit 122 reserves, in the user space, a memory area for storing the procfs, and issues a system call with designation of the memory area. After acquiring the procfs, the procfs referring unit 122 distributes the procfs to one or more processes individually corresponding to a command.

The shared memory unit 123 is a shared memory area used by the kstat referring unit 121 and the procfs referring unit 122. In the shared memory unit 123, a shared buffer is created to temporarily store therein system statistical information (kstat or procfs), which is a response result for a system call, prior to distribution to command processes. In addition, a reference counter used for controlling the distribution of the system statistical information is created. The shared buffer and the reference counter are described in detail later. Note that the shared memory unit 123 does not have to be a shared memory area as long as it is storage means (for example, a memory file system) commonly available for use by multiple processes.

When a sar command is entered, the sar command unit 131 executes a process corresponding to the sar command. The sar command is used for acquiring load information, such as the CPU utilization. The sar command unit 131 acquires the kstat via the kstat referring unit 121, extracts pertinent data for load of the information processing device 100 from the kstat, and sorts out a format (display format) for the data and subsequently outputs the data to a command entry source.

When a vmstat command is entered, the vmstat command unit 132 executes a process corresponding to the vmstat command. The vmstat command is used for acquiring virtual memory information, such as paging and swapping. The vmstat command unit 132 acquires the kstat via the kstat referring unit 121, extracts pertinent data for a virtual memory from the kstat, and sorts out a format for the data and subsequently outputs the data to a command entry source.

When an iostat command is entered, the iostat command unit 133 executes a process corresponding to the iostat command. The iostat command is used for acquiring disk I/O (input/output) information. The iostat command unit 133 acquires the kstat via the kstat referring unit 121, extracts pertinent data for disk I/O from the kstat, and sorts out a format for the data and subsequently outputs the data to a command entry source.

When an mpstat command is entered, the mpstat command unit 134 executes a process corresponding to the mpstat command. The mpstat command is used for acquiring detailed information on the CPU, such as the occurrence of CPU interrupts and CPU wait time. The mpstat command unit 134 acquires the kstat via the kstat referring unit 121, extracts pertinent data for the CPU from the kstat, and sorts out a format for the data and subsequently outputs the data to a command entry source.

When a ps command is entered, the ps command unit 135 executes a process corresponding to the ps command. The ps command is used for acquiring a list of processes running on the information processing device 100. The ps command unit 135 acquires the procfs via the procfs referring unit 122, extracts data used to create the process list from the procfs, and sorts out a format for the data and subsequently outputs the data to a command entry source.

When a prstat command is entered, the prstat command unit 136 executes a process corresponding to the prstat command. The prstat command is used for acquiring operation status for each process, such as a process execution time. The prstat command unit 136 acquires the procfs via the procfs referring unit 122, extracts pertinent data for the process operation status from the procfs, and sorts out a format for the data and subsequently outputs the data to a command entry source.

When a pfiles command is entered, the pfiles command unit 137 executes a process corresponding to the pfiles command. The pfiles command is used for acquiring a list of files to which processes are referring. The pfiles command unit 137 acquires the procfs via the procfs referring unit 122, extracts pertinent data for the file reference status from the procfs, and sorts out a format for the data and subsequently outputs the data to a command entry source.

Thus, for the information processing device 100, multiple types of commands are provided to acquire system statistical information. Data content and format to be output vary according to the type of command. As for the sar command, the vmstat command, the iostat command, and the mpstat command, data to be output is generated based on the kstat. On the other hand, as for the ps command, the prstat command, and the pfiles command, data to be output is generated based on the procfs. Each unit for executing a corresponding command process processes system statistical information and responds to a command entry source with the processed system statistical information. Note that seven types of commands are described above as examples, however, other types of commands may also be provided.

A command may be entered into the information processing device 100 by a user using the input device 22. In that case, the information processing device 100 may present a processing result of the entered command on the display 21. In addition, a command may be entered into the information processing device 100 by a different information processing device via the network 24. In that case, the information processing device 100 may transmit a processing result of the entered command to the different information processing device via the network 24.

Each time a command is entered into the information processing device 100, a process corresponding to the entered command is launched in the user space, and processing of a unit (for example, the sar command unit 131) corresponding to the type of the command is started in the launched process. The process in the user space calls the kstat referring unit 121 or the procfs referring unit 122 in order to acquire system statistical information (for example, calls a library function). Processing of the called kstat referring unit 121 or procfs referring unit 122 is executed in the calling process.

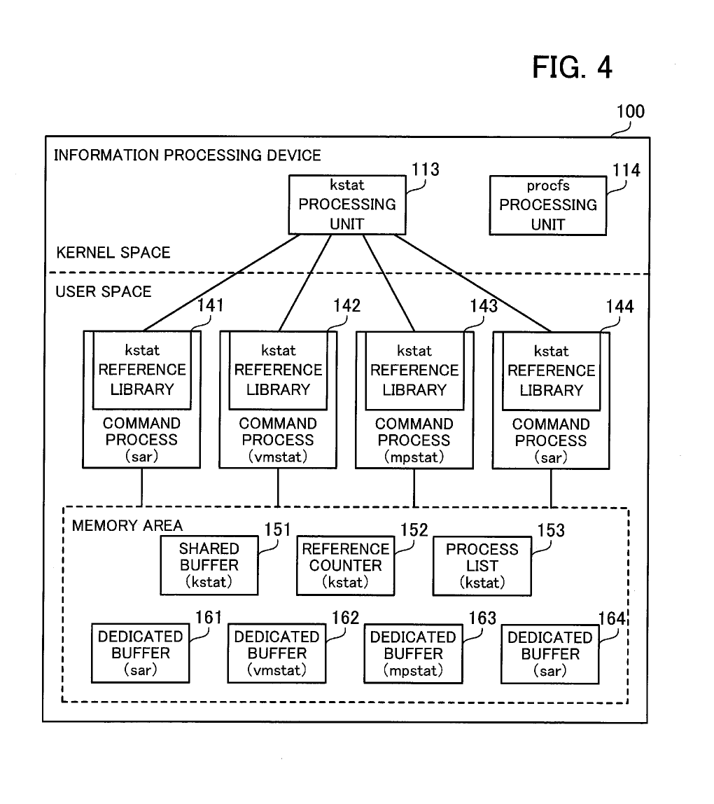

FIG. 4 illustrates an example of command process execution on the information processing device. FIG. 4 illustrates a case in which four commands of a sar command, a vmstat command, an mpstat command, and a sar command are sequentially entered into the information processing device 100.

When the first sar command is entered, a command process 141 for executing processing defined by the sar command unit 131 is launched. When the vmstat command is entered, a command process 142 for executing processing defined by the vmstat command unit 132 is launched. When the mpstat command is entered, a command process 143 for executing processing defined by the mpstat command unit 134 is launched. When the second sar command is entered, a command process 144 for executing processing defined by the sar command unit 131 is launched.

Each of the command processes 141 to 144 calls the kstat reference unit 121 to acquire the kstat, and executes therein processing defined by the kstat referring unit 121. FIG. 4 illustrates a case in which the kstat referring unit 121 is implemented as a library program. Processing for issuing a system call is defined within the processing of the kstat referring unit 121. Depending on timing of the commands to be entered, some or all of the command processes 141 to 144 issue a system call.

In the memory area, dedicated buffers 161 to 164 corresponding one-to-one with the command processes 141 to 144 are generated. Each of the dedicated buffers 161 to 164 is used to process the kstat according to the corresponding type of command. In the shared memory unit 123, a shared buffer 151 and a reference counter 152 are created which are commonly available for reference by all the command processes 141 to 144. The shared buffer 151 stores unprocessed kstat which is acquired from the kstat processing unit 113 in response to issuance of a system call. The reference counter 152 is referred to when the acquired kstat is distributed to one or more of the command processes 141 to 144. In addition, a process list 153 indicating running command processes is created in the memory area.

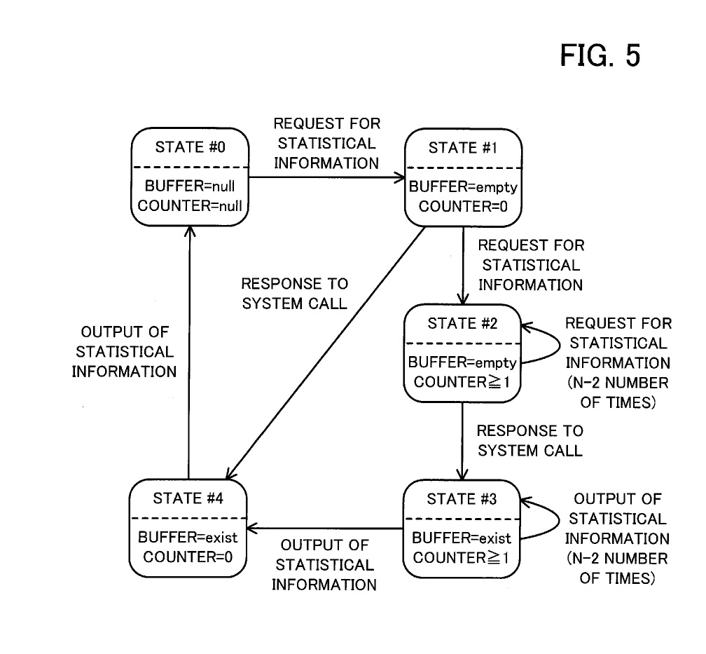

FIG. 5 is a state transition diagram illustrating reference states of system statistical information. The reference state is managed by the kstat referring unit 121 or the procfs referring unit 122 for each system call. The reference state takes one of the following five states, States #0 to #4.

State #0 represents that no system call has been issued. In State #0, a shared buffer and a reference counter corresponding to a system call are not created in the shared memory unit 123. If a command process calls the kstat referring unit 121 or the procfs referring unit 122 (to request system statistical information) when the reference state is State #0, a system call is issued and the reference state makes a transition to State #1.

State #1 represents that one command process has requested system statistical information and is waiting for a response to the system call. In State #1, a shared buffer and a reference counter corresponding to the system call have been created in the shared memory unit 123. In State #1, the shared buffer is empty and the reference counter has a value of 0. If another command process requests the system statistical information when the reference state is State #1, the reference state makes a transition to State #2. On the other hand, the reference state makes a transition to State #4 once a response result (the kstat or procfs) for the system call is acquired.

State #2 represents that two or more command processes have requested the system statistical information and are waiting for a response to the system call. In State #2, the shared buffer corresponding to the system calls is empty, and the reference counter indicates a value equal to or more than 1. The value of the reference counter indicates the number of command processes waiting for the system statistical information other than the command process for which the system call has been issued. If another command process also requests the system statistical information when the reference state is State #2, the reference state is maintained in State #2. If the total of N command processes (N is an integer equal to or larger than 2) request the system statistical information, State #2 makes a self-transition N−2 times (i.e., the reference state is maintained in State #2 N−2 times). On the other hand, the reference state makes a transition to State #3 once a response result for the system call is acquired.

State #3 represents that the system statistical information has been acquired in response to the system call but has yet to be distributed to the two or more command processes. In State #3, the shared buffer corresponding to the system call stores therein unprocessed system statistical information and the reference counter indicates a value equal to or more than 1. If the unprocessed system statistical information is copied to a dedicated buffer corresponding to one of the command processes when the reference state is State #3, the value of the reference counter is decremented by one. At this point, if the value of the reference counter after the update is equal to or more than 1, the reference state is maintained in State #3. On the other hand, if the value of the reference counter after the update is 0, the reference state makes a transition to State #4. Note that State #3 makes a self-transition N−2 times.

State #4 represents that the system statistical information has been acquired in response to the system call and there is one command process to which the system statistical information has yet to be distributed. In State #4, the shared buffer corresponding to the system call stores therein the unprocessed system statistical information and the reference counter has a value of 0. If the system statistical information is copied to a dedicated buffer corresponding to the remaining one command process when the reference state is State #4, the shared buffer and the reference counter are deleted from the shared memory unit 123 and the reference state makes a transition to State #0.

Note that in the case where there is only one command process waiting for the system statistical information upon acquisition of the response to the system call (i.e., the case where the reference state makes a transition from State #1 to State #4), the system statistical information may be written directly to the dedicated buffer without passing through the shared buffer.

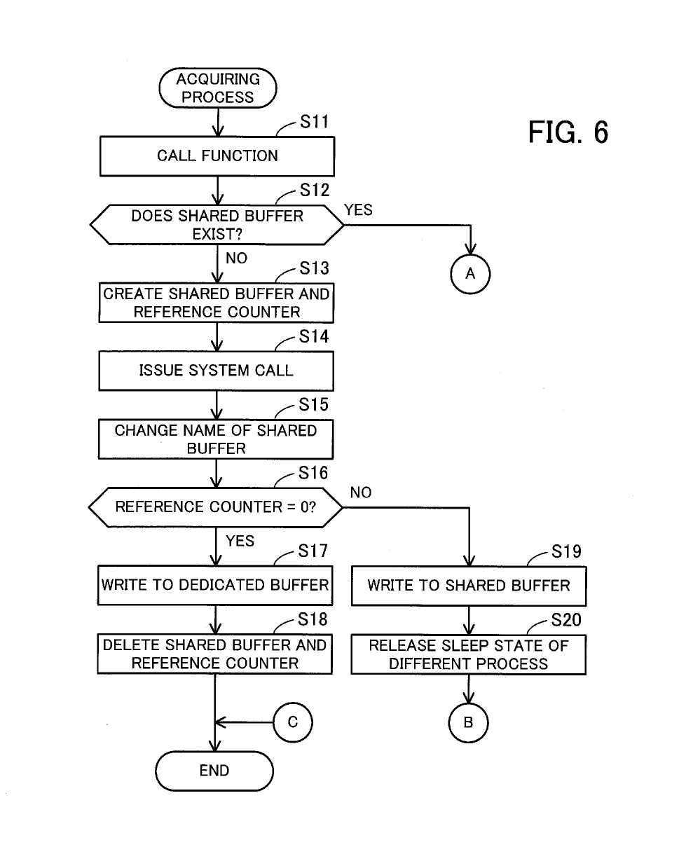

FIG. 6 is a flowchart illustrating a process of acquiring system statistical information. The kstat referring unit 121 and the procfs referring unit 122 individually execute the process of FIG. 6 each time being called by a command process. The process of FIG. 6 is described next according to the step numbers in the flowchart, with an assumption where the kstat referring unit 121 is called.

(Step S11) The kstat referring unit 121 receives a function call (for example, a library function call) from a command process corresponding to the sar command unit 131, the vmstat command unit 132, the iostat command unit 133, or the mpstat command unit 134. The kstat referring unit 121 records identification information (for example, a process identifier) of the calling command process in the process list 153.

(Step S12) The kstat referring unit 121 determines whether the shared buffer 151 exists in the shared memory unit 123. If the shared buffer 151 exists, the kstat referring unit 121 determines that there is a system call waiting for a response and, then, proceeds to step S21. On the other hand, if the shared buffer 151 does not exist, the kstat referring unit 121 determines that there is no system call waiting for a response and, then, proceeds to step S13.

(Step S13) The kstat referring unit 121 creates, in the shared memory unit 123, the shared buffer 151 and the reference counter 152 for the kstat. At this point, the shared buffer 151 is empty and the reference counter 152 has been initialized to 0.

(Step S14) The kstat referring unit 121 reserves, in the user space, a memory area to which a response result for a system call is to be written, and then issues the system call with designation of the memory area to the kstat processing unit 113. Subsequently, the kstat referring unit 121 waits for a response from the kstat processing unit 113.

(Step S15) When receiving a response to the system call from the kstat processing unit 113, the kstat referring unit 121 changes a buffer name of the shared buffer 151 created in step S13. The buffer name change hides the existence of the shared buffer 151. As a result, in the process of step S12 from then on, the kstat referring unit 121 determines that the shared buffer for the kstat does not exist in the shared memory unit 123 and, therefore, determines that there is no system call waiting for a response.

(Step S16) The kstat referring unit 121 determines whether the value of the reference counter 152 is 0. If the value is 0, the kstat referring unit 121 determines that a command process other than the calling command process of step S11 does not exist and, then, proceeds to step S17. If the value is 1 or more, the kstat referring unit 121 determines that another command process exists and, then, proceeds to step S19.

(Step S17) The kstat referring unit 121 writes the system statistical information (kstat) stored in the memory area reserved in step S14 to a dedicated buffer corresponding to the calling command process of step S11. Not having the system statistical information passing through the shared buffer 151 reduces the number of times the system statistical information is copied. Note however that the system statistical information may be written once to the shared buffer 151 before being written to the dedicated buffer. The system statistical information written to the dedicated buffer is processed by the calling command process.

(Step S18) The kstat referring unit 121 deletes, from the shared memory unit 123, the shared buffer 151 (whose buffer name has been changed) and the reference counter 152 created in step S13. Subsequently, the kstat referring unit 121 ends the process.

(Step S19) The kstat referring unit 121 writes the system statistical information stored in the memory area reserved in step S14 to the shared buffer 151 (whose buffer name has been changed) created in step S13.

(Step S20) With reference to the process list 153, the kstat referring unit 121 identifies a command process being in a sleep state while waiting for a response to the system call. The kstat referring unit 121 then notifies the identified command process of an interrupt message using interprocess communication to thereby release the sleep state. Subsequently, the kstat referring unit 121 proceeds to step S23.

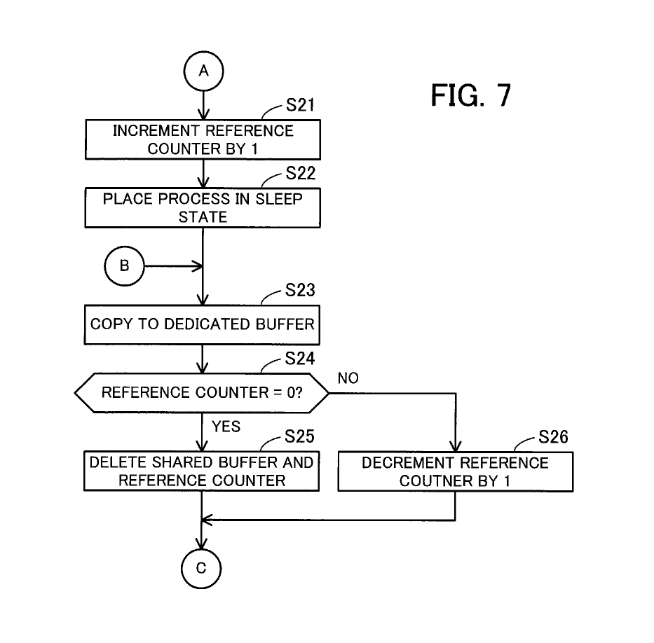

FIG. 7 is a flowchart illustrating the process of acquiring the system statistical information, continuing from FIG. 6.

(Step S21) The kstat referring unit 121 increments the value of the reference counter 152 created in the shared memory unit 123 by one.

(Step S22) The kstat referring unit 121 places the calling command process in a sleep state so as to wait for a response to the system call which has already been issued. With this, no CPU time is allocated to the command process until a response to the system call is made. Subsequently, on receiving the notification from a different command process (step S20), the command process returns from the sleep state to a running state or a ready state.

(Step S23) The kstat referring unit 121 copies the system statistical information from the shared buffer 151 created in the shared memory unit 123 to a dedicated buffer corresponding to the calling command process. Note that the command process having changed the buffer name of the shared buffer 151 may notify a different command process of the changed buffer name.

(Step S24) The kstat referring unit 121 determines whether the value of the reference counter 152 is 0. If the value is 0, the kstat referring unit 121 determines that there is no other command process to which the system statistical information has yet to be distributed and, then, proceeds to step S25. On the other hand, if the value is 1 or more, the kstat referring unit 121 determines that there is another command process and, then, proceeds to step S26.

(Step S25) The kstat referring unit 121 deletes the shared buffer 151 and the reference counter 152 from the shared memory unit 123 and, then, ends the process.

(Step S26) The kstat referring unit 121 decrements the value of the reference counter 152 by one and, then, ends the process in relation to the calling command process.

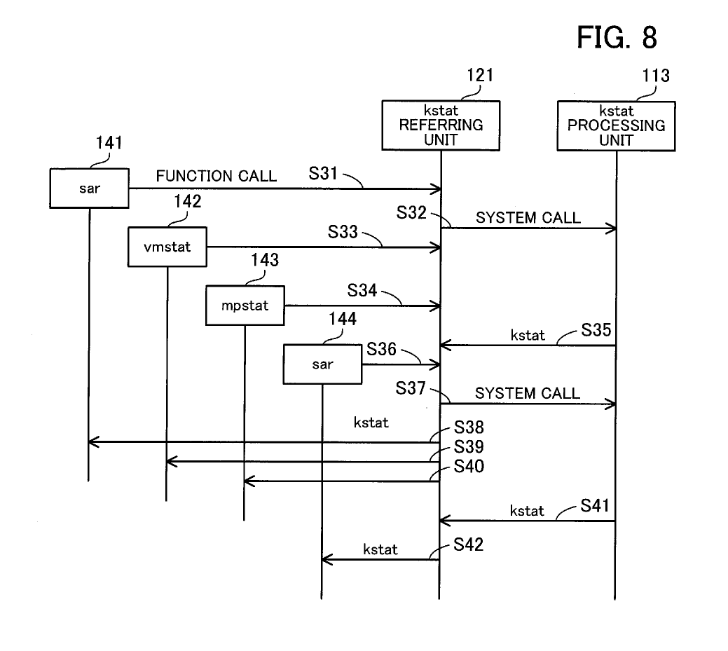

FIG. 8 illustrates an example of a sequence to acquire system statistical information. This example is concerned with the case in which the command processes 141 to 144 are sequentially launched as illustrated in FIG. 4.

When the first sar command is entered, the command process 141 calls the kstat referring unit 121 (step S31). Upon determining that a shared buffer does not exist in the shared memory unit 123, the kstat referring unit 121 creates the shared buffer 151 and issues a system call (step S32). Subsequently, when the vmstat command is entered, the command process 142 calls the kstat referring unit 121 (step S33). In addition, when the mpstat command is entered, the command process 143 calls the kstat referring unit 121 (step S34). Upon determining that the shared buffer 151 exists, the kstat referring unit 121 waits for a response to the system call without issuing a new system call.

Upon receiving a response to the system call from the kstat processing unit 113, the kstat referring unit 121 changes the buffer name of the shared buffer 151 and stores the system statistical information (kstat) in the shared buffer 151 (step S35). Subsequently, when the second sar command is entered, the command process 144 calls the kstat referring unit 121 (step S36). Upon determining that a shared buffer with an unchanged buffer name does not exist in the shared memory unit 123, the kstat referring unit 121 creates a new shared buffer and issues a system call (step S37).

The kstat referring unit 121 copies the system statistical information stored in the shared buffer 151 to the dedicated buffers 161 to 163 corresponding one-to-one with the command processes 141 to 143 (steps S38 to S40). On the other hand, upon receiving a response to the system call from the kstat processing unit 113, the kstat referring unit 121 writes the system statistical information to the dedicated buffer 164 corresponding to the command process 144 (steps S41 and S42). Note that the dedicated buffers 161 to 164 are created by the command processes 141 to 144, respectively, which know locations (memory addresses) of the corresponding dedicated buffers 161 to 164.

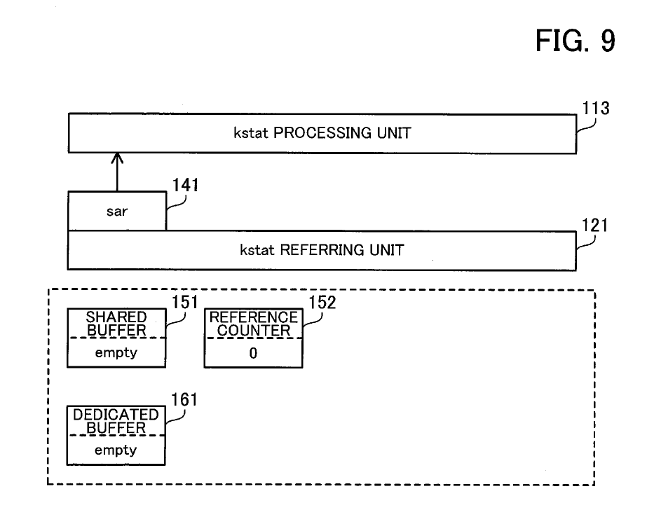

FIG. 9 is a first diagram illustrating an example of change in data in a memory area. When calling the kstat referring unit 121 (step S31 above), the command process 141 creates, in the RAM 102, the dedicated buffer 161 which is empty at this point. When issuing a system call through the kstat referring unit 121 (step S32 above), the command process 141 creates, in the RAM 102, the shared buffer 151 which is empty at this point and the reference counter 152 initialized to 0.

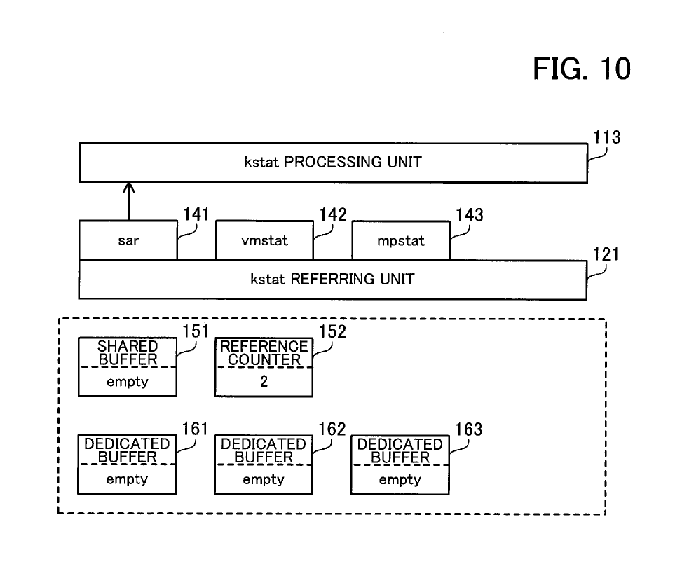

FIG. 10 is a second diagram illustrating the example of change in data in the memory area. When calling the kstat referring unit 121 (step S33 above), the command process 142 creates, in the RAM 102, the dedicated buffer 162 which is empty at this point. In addition, the command process 142 increments the reference counter 152 to 1 through the kstat referring unit 121. When calling the kstat referring unit 121 (step S34 above), the command process 143 creates, in the RAM 102, the dedicated buffer 163 which is empty at this point. In addition, the command process 143 increments the reference counter 152 to 2 through the kstat referring unit 121.

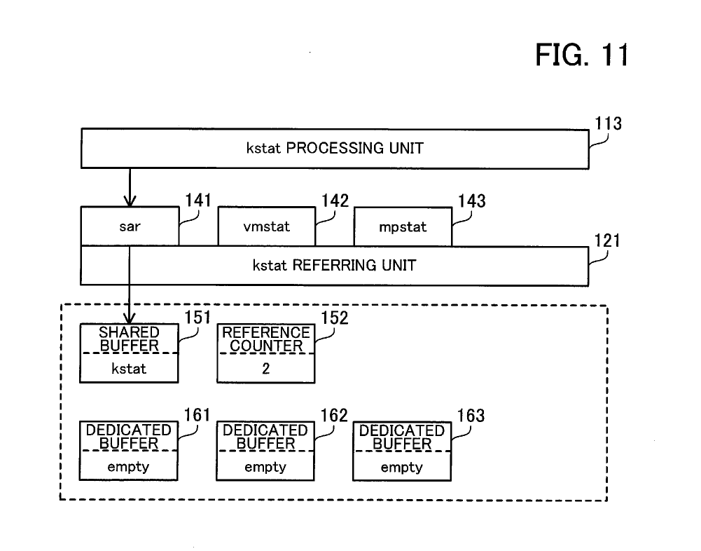

FIG. 11 is a third diagram illustrating the example of change in data in the memory area. Upon acquiring the system statistical information from the kstat processing unit 113 (step S35 above), the command process 141 changes the buffer name of the shared buffer 151 and writes the unprocessed system statistical information to the shared buffer 151. In addition, the command process 141 releases the sleep state of the command processes 142 and 143 registered in the process list 153.

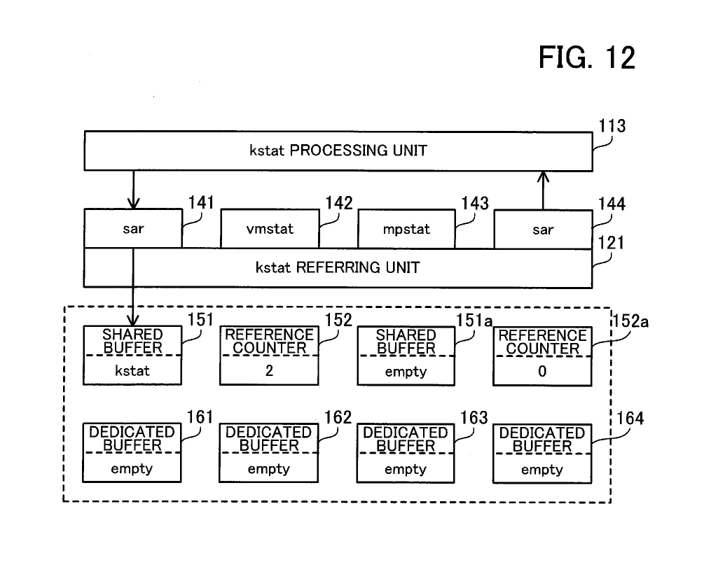

FIG. 12 is a fourth diagram illustrating the example of change in data in the memory area. When calling the kstat referring unit 121 (step S36 above), the command process 144 creates, in the RAM 102, the dedicated buffer 164 which is empty at this point. When issuing a system call through the kstat referring unit 121 (step S37 above), the command process 144 creates, in the RAM 102, a new shared buffer (a shared buffer 151a) which is empty at this point and a new reference counter (a reference counter 152a) initialized to 0.

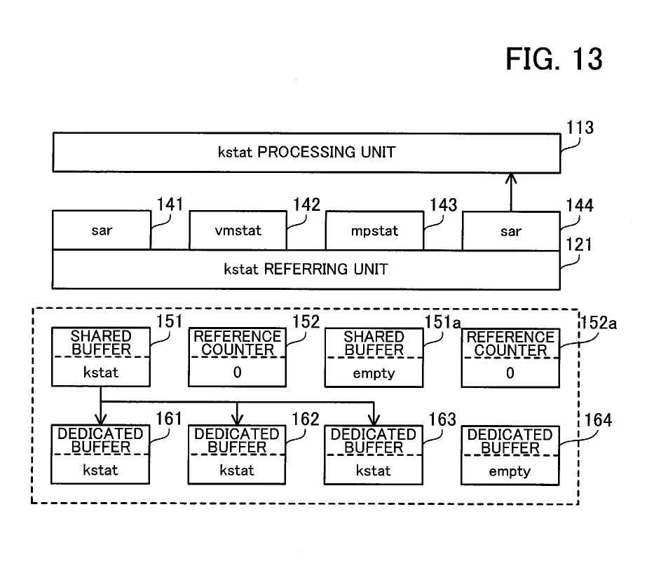

FIG. 13 is a fifth diagram illustrating the example of change in data in the memory area. The command process 141 copies the system statistical information of the shared buffer 151 to the dedicated buffer 161 through the kstat referring unit 121, and decrements the reference counter 152 to 1 (step S38 above). The command process 142 copies the system statistical information to the dedicated buffer 162 and decrements the reference counter 152 to 0 (step S39 above). The command process 143 copies the system statistical information to the dedicated buffer 163 and deletes the shared buffer 151 and the reference counter 152 (step S40 above).

In the command processes 141 to 143, the process of the kstat referring unit 121 ends with copying of the system statistical information from the shared buffer 151 to the individual dedicated buffers 161 to 163. Subsequently, the command process 141 uses the system statistical information of the dedicated buffer 161 to create data corresponding to the sar command and then outputs the data. The command process 142 uses the system statistical information of the dedicated buffer 162 to create data corresponding to the vmstat command and then outputs the data. The command process 143 uses the system statistical information of the dedicated buffer 163 to create data corresponding to the mpstat command and then outputs the data.

Note that the processing of the command processes 141 to 143 after the system statistical information is stored in the shared buffer 151 (i.e., the processing in steps S38 to S40 above) may be executed in any order. Although FIG. 8 illustrates an example in which the processing is executed in the order of the command processes 141, 142, and 143, the processing may be executed in a different order. The execution order of the command processes 141 to 143 may be determined based on OS process scheduling. Note however that it is desirable that no process switching take place during the period of time from the confirmation of the value of the reference counter 152 to the update of the reference counter 152.

According to the information processing device 100 of the second embodiment, it is possible to reduce the number of issuances of system calls as compared to the case where a system call is issued for each command process, which in turn reduces the load imposed on the information processing device 100 in processing the commands. In addition, it is possible to prevent command processes from being executed based on old system statistical information because a new system call is issued if there is no system call waiting for a response, thus promoting consistency between system statistical information managed in the kernel space and the command processes. Furthermore, compared to the method where a cache of the system statistical information is held in the user space at all times, the load for maintaining cache coherence is reduced.

In addition, unprocessed system statistical information (raw data) to which a process according to the type of command has yet to be applied is stored in the shared buffer 151 and then distributed to multiple command processes. Therefore, the system statistical information acquired with a single system call is usable for processes of multiple commands of different types. In addition, the buffer name of the shared buffer 151 is changed when a response to the system call is received. With this, it is possible to determine whether there is a system call waiting for a response by confirming whether a shared buffer with a predetermined name exists in the shared memory unit 123.

Note that the command control method of the second embodiment may be achieved by causing the information processing device 100 having functions to serve as a computer to implement a command control program. The command control program may be recorded on computer-readable recording media (for example, the recording medium 23). Such recording media include a magnetic disk, an optical disk, a magneto-optical disk, and a semiconductor memory. Examples of the magnetic disk are a flexible disk (FD) and a HDD. Examples of the optical disk are a compact disk (CD), a CD recordable (CD-R), a CD rewritable (CD-RW), a digital versatile disk (DVD), a DVD-R, and a DVD-RW.

In the case of distributing the program, for example, portable recording media on which the program is recorded are sold. In addition, the program may be stored in a memory device of another computer and then distributed via the network 24. The information processing device 100 stores, in a memory device such as the HDD 103, the program originally recorded on the portable recording medium or received from the different computer. Subsequently, the information processing device 100 reads the program from the memory device and performs processing according to the program. Note however that the information processing device 100 may directly implement the program read from the portable recording medium, or may directly implement the program received from the different compute via the network 24.

According to one aspect, the load imposed on a computer in command processing is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A command control method executed by a computer for issuing an operating system call and carrying out a process corresponding to a command, the command control method comprising:
determining, by a processor of the computer, whether a first system call waiting for a response exists upon entry of the command to the computer, the first system call having been issued based on a different command entered into the computer prior to the command;
carrying out, by the processor, the process corresponding to the command with use of a response result for the first system call when the first system call exists; and
issuing, by the processor, a second system call and carrying out the process corresponding to the command with use of a response result for the second system call when the first system call does not exist.

2. The command control method according to claim 1, further comprising storing, by the processor, the response result for the first system call in a buffer upon acquisition of the response result for the first system call and then providing processes individually corresponding to the command and the different command with the response result stored in the buffer.

3. The command control method according to claim 2, further comprising:
managing, by the processor, a count of one or more commands including the command with use of a counter created in a memory, the one or more commands being entered into the computer for duration of the first system call waiting for the response; and
controlling, by the processor, with reference to the counter, the providing of the response result stored in the buffer for processes individually corresponding to the one or more commands.

4. The command control method according to claim 3, further comprising deleting, by the processor, the buffer after the providing of the response result stored in the buffer for the processes individually corresponding to the one or more commands and the different command.

5. The command control method according to claim 2, further comprising:
creating, by the processor, the buffer in a memory when issuing the first system call; and
rewiring, by the processor, identification information for identifying the buffer in the memory at a time of the storing.

6. The command control method according to claim 1, wherein the command and the different command are for acquiring system statistical information managed by an operating system.

7. A computer-readable storage medium storing a computer program, the computer program causing a computer for issuing an operating system call and carrying out a process corresponding to a command to perform a procedure comprising:
determining whether a first system call waiting for a response exists upon entry of the command to the computer, the first system call having been issued based on a different command entered into the computer prior to the command;
providing the process corresponding to the command with a response result for the first system call when the first system call exists; and
issuing a second system call and providing the process corresponding to the command with a response result for the second system call when the first system call does not exist.
